(19) United States
(12) Patent Application Publication
(10) Pub. No.: US 2012/0085966 A1
(43) Pub. Date: Apr. 12, 2012

(54) Composition and Methods for Maintaining pH Balance in Pool and Spa Water

(76) Inventor: Abraham Ziegler, San Diego, CA (US)

(21) Appl. No.: 12/899,528

(22) Filed: Oct. 6, 2010

(51) Int. Cl. C02F 5/08; C02F 5/10

(52) U.S. Cl. 252/181; 252/175

(57) ABSTRACT

The present invention is directed, in part, to a composition of about 60 parts by weight calcium oxide and about 40 parts by weight magnesium oxide that is administered as a buffering agent to a pool or spa in a ratio of approximately 1 cup of composition to 500 gallons of pool or spa water. The composition is produced in either a granular powder form or into a tablet form, the tablet form being capable of being fitted into a manufactured device that occupies a position upstream of the pool or spa water filter and in doing so, stabilizes and buffers the pH of the water entering the filter to about a range of between 7.2 and 7.8. The invention is also directed to enhancing the effectiveness of chlorine in sanitizing pool or spa water by removing the negative effects of phosphate compounds in the pool or spa water.

### FIELD OF THE INVENTION

The present invention relates generally to chemical reagents used in the maintenance of commercial and recreational pools, spas or other bodies of water in which humans bathe or swim. Specifically, the invention relates to a chemical composition that acts to buffer the pH level within an acceptable range, removes phosphates and increases the effectiveness of chlorine in hot tubs, spas, pools and other similar recreational bodies of water.

### BACKGROUND OF THE INVENTION

Until recently, spas, swimming pools and hot tubs were reserved for the exclusive and affluent members of society. Often, hot tubs are utilized after engaging in rigorous exercise and home spas are frequently on the requisite lists of prospective homebuyers. However, despite all the appealing features of a hot tub or swimming pool, there is a great deal of responsibility in maintaining proper chemical composition and water balance. Routine and diligent maintenance is required in keeping a hot tub and swimming pool clean and free from algae and dirt. Most hot tub and pool owners utilize a pump and filter system in conjunction with chorine to keep the water clear and bacteria free. This system operates with jets circulating the water into a drainage system. The water is then filtered by means of a diatomaceous earth filter, cartridge filter, or sand filter. The filtered water is then piped through the system and back into the main body of water.

The benefits of a hot tub or spa are particularly appealing to individuals who suffer physical ailments ranging from pulled muscles to arthritis. This form of therapeutic relief is typically known as hydrotherapy. In addition to its therapeutic value, soaking can be used as a simple yet efficient means to relax and reduce stress.

In addition, spas and pools feature walls and floors that require periodic brushing and cleaning because these surfaces collect algae, scum, mildew, and grease deposits that are not directly cleaned by running the pump/filter system. In order to maintain water chemistry, owners must treat their pool or spa water with various chemicals such as soda ash, dry acid, chlorine, de-foamers, algaecides, phosphate removers and clarifiers. Such agents are added as needed to help keep the water clean and clear and to maintain appropriate water chemistry.

Swimming pools, Jacuzzis and spas contain significant amounts of water which can become stagnant and during typical use bacteria is introduced which alters the chemical and pH conditions of the water requiring introduction of chemical agents to maintain the usability of the pool or spa. Harboring of bacteria or other organic matter is particularly problematic in pools in which the water is heated. As such, pool disinfectants and pH stabilizers have been developed and used to keep the pool conditions optimal for swimming or bathing and to keep the pool bacterial levels below the maximum acceptable level.

Normal maintenance of swimming pool and spa water involves four basic steps; maintenance of the balance of pH, sanitization of water, addition of algaecides and treatment with water clarifiers. The present invention provides a solution and overcomes the deficiency of one necessarily having to keeping all four steps in balance and allows pool and spa owners to reduce the process to two steps. First, the present invention acts to buffer the pH of a pool, spa or other recreational body of water at appropriate levels for human use. Second, the invention assists in maintaining the effectiveness of chlorine in the pool or spa for purposes of ensuring sanitized water. In doing so, pool and spa owners enjoy a cleaner pool which is easier to maintain than traditional water treatment processes.

The use of chlorine as a disinfectant for swimming pool water and other aqueous media is well known. In such use, it is important to employ chlorine in sufficient amounts as to maintain a microbicidal concentration of chlorine while also preventing the introduction of too much chlorinated agents which contribute to an offensive chlorine-associated odors and burning of the eyes during swimming. Without periodic addition of chlorinated agents, the effective level of chlorine needed to prevent bacterial growth is diminished over time leading to pH imbalance, growth of bacteria and algae and production of offensive odors.

The prior art is replete with chemical agents and other devices related to maintaining the pH and bacterial levels of pools and spas. For example, U.S. Pat. No. 6,054,056 to Maziuk et. al., discloses a pool buffering composition comprising 90 to 91% by weight alkali metal bicarbonate and 6.5 to 7.5% by weight alkali metal carbonate and at least one binder and/or clarifier. As described therein, the formulation can be administered to a pool or spa simultaneously during addition of chlorine provides a buffering capacity which maintains the pH levels so that water can be used by bathers. This formulation employs well known buffering agents (i.e., bicarbonates, carbonates) and purportedly maintains pH at acceptable levels. However the solubility of certain buffering agents is admittedly often less than optimal. For example, sesquicarbonate, a composite of both carbonate and bicarbonate, has relatively low solubility and dissolves slowly when employed as an alkalinizer. Furthermore, the use of certain alkali buffering agents, which also dissolve slowly and hence, rest on the pool floor, can cause staining, especially in pools constructed with colored tile.

Other inventions have attempted to maintain proper pH levels by preventing the growth of bacteria which can produce pH altering conditions in pools and spas, which in turn can lead to the growth of algae, further complicating the maintenance of these recreational and therapeutic devices. For example, U.S. Pat. No. 6,146,539 to Mills describes methods and compositions for treatment of pools, spas and the like, by removing one or more nutrients necessary for algal growth. As described therein, the invention acts by removing elements such as phosphorous and phosphate, agents necessary for the growth of algae, and in doing so, algae is “starved” for lack of nutrients and cannot proliferate. Although the invention is arguably useful in preventing the initiation and growth of algae, it does not address the problem of a common root cause of algae growth in pools and spas, namely, high pH in the water.

U.S. Pat. No. 5,614,528 to Jones et al. discloses compositions and methods for sanitizing aqueous media by combining a chlorine-source composition and a glycoluril-source composition. Specifically, the glycoluril composition acts by stabilizing chlorine in the aqueous media, thus prolonging its useful life as a microbicidal agent which also purportedly acts to reduce the formation of chloramines, trihalomethanes and the production of offensive odors. However, materials that act to stabilize chlorine in such a way often are prohibitively expensive for routine use in maintenance of pools and spas leaving these compositions out of the financial reach of many consumers.

Accordingly, difficulties in regulating the chemical balance of a pool or hot tub, especially with regard to maintenance of pH and chlorine concentrations, remain. Further, existing solutions for eliminating chemical balance issues all have particular deficiencies which do not fully address the difficulty in properly buffering the pH and maintaining the chlorine levels of a spa or pool. The present invention addresses these shortcomings.

### SUMMARY OF THE INVENTION

The present invention is directed to a composition and methods of use of about 60 parts by weight calcium oxide and about 40 parts by weight magnesium oxide that is administered as a buffering agent to a pool or spa in a ratio of approximately 1 cup of the composition to 500 gallons of pool or spa water. The composition is produced in either a granular powder form or into a tablet form, the tablet form being capable of being fitted into a manufactured device that occupies a position upstream of the pool or spa water filter and in doing so, stabilizes and buffers the pH of the water entering the filter to about a range of between 7.2 and 7.8.

The present invention is also directed to a composition and methods for use in pool or spa water wherein the composition acts to increase the sanitizing effectiveness of chlorine and which is administered with at least approximately 2 parts by weight to about 4 parts by weight of at least one member selected from the group consisting of binders dispersing aids and clarifiers.

### DETAILED DESCRIPTION OF THE INVENTION

The present invention provides a composition and methods that employ selected ratios of magnesium oxide and calcium oxide and selected other chemicals to effectively buffer and maintain the pH level of the water in a pool or spa, or other aqueous media within a desired range appropriate for human bathing and swimming. The composition is mixed to form an appropriate ratio of the materials or alternatively, can be mixed to form a tablet or granular powder.

It is therefore, a primary object of the present invention to provide a composition and methods that effectively maintain the pH of aqueous media such as for example, in a pool or spa, when administered in combination with chlorine or other bactericides or algaecides. As disclosed herein, the present invention maintains pH within a desired range by buffering the aqueous media with a combination of magnesium, calcium or other appropriate elemental oxides. The present invention also relates to a composition to be used in combination with chlorine additives which allow pool and spa users to maintain an appropriate level of chlorine in the subject water while also providing a desirable pH level. Hence, maintenance is greatly simplified to two easy steps, giving users a cleaner pool or spa.

For use in a spa or pool the present invention is employed by preparing a cloth or synthetic pouch that will house the composition. The cloth pouch is prepared and fastened to the spa in such a way that the hot water will not cause the cloth to slowly dissolve but rather will allow water to flow over the composition relatively freely. The present invention can also be applied to spa water through the use of a cylindrical or other appropriately shaped device or vessel that houses the composition and which is fitted with numerous small holes so to allow water to pass easily through the mixture of the present invention. The preferred location of this vessel is on top or inside of the spa cartridge filter. The composition can also be prepared independent of a device or vessel and instead, pressed into a dissolvable hard tablet that can be put in place of the vessel. Another location of the vessel or tablet of the invention can be any location up line from the filter, up line being any location that is in the piping system that circulates the water before the filter. The vessel or tablet can also be placed in any location that is under the water line of the spa. Once the composition has dissolved entirely, the vessel can be fitted with additional composition and replaced in the spa. Alternatively, a new tablet can be put in place of the dissolved tablet.

For use to buffer and maintain pH in a typical pool, one 1 cup for each 500 gallons of water is added every two weeks during the summer months and once a month or less during the winter months. The procedure for adding the present invention to a pool is as follows; first, pour the correct amount of the present invention directly into the pool skimmer or other water return that is up line of the main filter. The composition is then transferred to the filter causing water to pass over the mixture of the composition and in doing so, maintains the proper pH and removes phosphates each time the pump and filter are in operation. After each filter cleaning, an additional amount of composition is added to the water. Sanitation of the water is provided because the claimed composition acts to remove phosphates, and chloramines while maintaining the proper pH balance of pool and spa water. In doing so, the present invention prevents the water's pH from dropping below 7.2.

Further, the composition claimed herein binds phosphates in the water, thereby eliminating the main source of nutrition for algae. Calcium oxide in the presence of phosphates will combine and precipitate out as an inert substance (calcium phosphate), which prevents algal blooms. The following example shows the molecular process that is occurring in the water between calcium oxide and phosphates in pool or spa water:

3CaO(s)+3H₂O(l)+2PO₄³⁻(aq)------>Ca₃(PO₄)₂(s)+6OH⁻(aq)

The composition described herein, in the ratios illustrated, provide pH buffering within a desired range, removal of phosphates from water, and increased effectiveness of chlorine. In order to determine the effectiveness of the claimed composition in buffering pH and in increasing the sanitizing capacity of chlorine in pools and spas, several experimental tests were conducted. The spa tested was in normal use during all testing phases. The testing illustrated that the claimed composition works as described herein in a typical pool and/or spa-type environment. Tests conducted also showed that the present invention increased the effectiveness of chlorine, the primary sanitizer used in most pools and spas. The testing was conducted according to the methods described in the Examples below and herein. A baseline was established with no composition placed into the spa. Baseline was established for both levels of chlorine: total available chlorine (TAC) and free available chlorine (FAC). The product was added and tested over a period of 3 weeks.

The results show that the product provided pH buffering and increased effectiveness of chlorine sanitation as FAC was determined to be at a higher level versus baseline levels. Chloramines are the result of insufficient free chlorine and usually result in a strong chlorine odor in and around the spa. Chloramines are formed as a product of nitrogen and active chlorine (NH₂Cl). Nitrogen is most commonly introduced into the spa water as ammonia in the form of sweat. Because combined chlorine is ineffective at sanitizing water, it is desirable to break the chemical bond that is created in combined chlorine. Current methods of remedying this condition are known as super saturation of chlorine, or shocking Chlorine works by combining with the organic matter in the water and essentially removing it from the water.

While in this combined state, chlorine is not effective in killing bacteria however, once the bond is broken chlorine again becomes an effective sanitizer. As an alternative to the shocking the water, the present invention can be employed. By placing the invention in the piping system in a manner described herein, water carrying the combined chlorine passes over the invention and chemical bonds are broken due to the reaction with and neutralization of oxides of sulfur and nitrogen, common bases in organic matter. As discussed in greater detail below, during testing, FAC was noticeably increased as a result.

The present invention also reacts and binds with phosphates in the same way as described herein when utilizing the invention in a packet. The testing conducted for phosphate concentrations was performed in the same manner as described above however during subsequent tests, phosphates where added to the water directly in order to establish a baseline for testing. The present invention allows users to administer the claimed composition in a combination ratio of about 60 parts by weight calcium oxide and about 40 parts by weight magnesium oxide. Other metal oxides with sufficient buffering capacity are also contemplated and encompassed within the scope of the present invention. In administering the composition to pool or spa water, a ratio of 1 cup of the claimed composition is combined with about 500 gallons of pool or spa water.

An alternative embodiment of the invention employs use of a pressed dissolvable tablet form of the composition which can be placed upstream of the pool or spa water filter so that water entering the filter is buffered to an appropriate level. The tablet is composed of either a compressed tablet (i.e., absent a holding device) which is placed directly in line upstream of the water filter or can be a tablet placed within a manufactured housing that fits inline upstream of the water filter and has contained thereon holes which allow the pool or spa water to flow through freely. A granular form (i.e., non-tablet form) of the claimed composition can also be placed in manufactured housing.

The term “buffering”, “buffer” or “buffer solution” as used herein refers to an aqueous solution having the property that the pH of the solution changes relatively little when a small amount of either a strong acid or base is added to it. Buffer solutions are used as a means of keeping pH at a nearly constant value in a wide variety of chemical applications. As described, the term also refers to ability of certain aqueous combinations of metal oxide materials to maintain pH of a solution at nearly a constant value despite being exposed to acidic or basic conditions. For example, the chemical combinations of magnesium oxide (MgO) and calcium oxide (CaO) used in conjunction with chlorine described herein will maintain pH of pool or spa water within a range of about 7.4 to 7.8 when administered to the water in appropriate concentrations.

The term “MgO” as used herein, refers to the chemical formula of magnesium oxide and includes all chemical grades of the compound. The invention as contemplated herein may also be used in combination with clarifiers, bactericidal agents and anti-algae materials.

The term “CaO” as used herein, refers to the chemical formula of calcium oxide and includes all chemical grades of the compound. The invention as contemplated herein may also be used in combination with clarifiers, bactericidal agents and anti-algae materials.

The term “spa,” “hot tub,” “body of water” or “pool” can be used interchangeably through-out the description. These terms are employed to refer to water used recreationally, therapeutically or otherwise.

The term “effects of phosphate containing compounds” or the like, as used herein refers to generally negative or adverse properties of water that contains a build-up of such compounds to the extent that a malodorous aroma or other unaesthetic characteristics become pervasive in the water. Further, the term “enhancing effectiveness of chlorine sanitization” or the like, as used herein, refers to a compounds ability to maintain, enhance or lengthen the effectiveness of chlorine sanitization qualities when compared to water in which is lacking the chlorine “enhancing” compound. For example, the claimed composition acts to enhance the effectiveness of chlorine sanitization in pool water when compared to pool water lacking the claimed composition.

The present invention is composed in part, of natural buffering agents, and as envisioned herein, utilizes various chemical grades of the buffering agents. Benefits of the present invention over the prior art include achieving pool or spa water and water conditions that are:
Natural
Clearer
Algae-free water
Low foam
Minimal chemicals needed
Less time to maintain
Lower maintenance costs

In a preferred embodiment of the invention the composition is pressed into a tablet or granular powder form which is then fitted into a device, vessel or other appropriate housing, that fits upstream of the pool or spa water filter and in doing so, buffers the water entering the filtration system to a pH of about 7.2 to 7.8.

In yet another preferred embodiment, the claimed composition is administered to pool or spa water in a ratio of about 60 parts by weight calcium oxide and about 40 parts by weight magnesium oxide (i.e., 60:40). The combination includes use of other appropriate ratios including 50:50, 65:35, 70:30, 75:25, 80:20, 85:15, 90:10, 95:5 parts calcium oxide to magnesium oxide. Alternatively, the combination includes use of 50:50, 65:35, 70:30, 75:25, 80:20, 85:15, 90:10, 95:5 parts magnesium oxide to calcium oxide.

In a preferred embodiment, the claimed composition is administered to pool or spa water in a ratio of about 1 cup of the composition to about 500 gallons of pool or spa water. Other ratios may be employed and are also encompassed within the scope of this invention. For example, 10 cups of composition can be administered to 5,000 gallons of pool or spa water depending on the degree of pH imbalance in the water. Greater amounts of the claimed composition per 10,000 gallons of water are also encompassed and within the scope of the present invention. In particular, for water requiring additional treatment, a ratio of 10 cups of composition can be added to 1,000 gallons, 800 gallons, 500 gallons and any other ratio that may be useful in sanitizing water and buffering pH therein.

To prepare a manufactured vessel appropriate for housing the claimed composition, a thermoplastic resin is employed to provide ease of manufacturing and low cost in preparing the vessel. In general, the claimed composition can be packaged in a durable, water-resistant container that can be safely stored near the hot tub or along with the other chemicals. Various models and styles of hot tubs, pools, spas and other aqueous media in both residential and commercial applications can employ use of the present invention thus, making the invention appealing to commercial enterprises that utilize pools and spas such as for example, hotels and other typical lodging facilities.

A selected quantity of the invention described herein can be packaged in a cylindrical plastic container blow-molded polyethylene terephthalate (PET) plastic to simplify administration in a pool or spa on a routine basis. The container will be prepared with a threaded lid and an integrated applicator manufactured from injection-molded plastic. The outside of the container can feature an adhesive label printed in one or more colors (including four-color process) on a pressure-sensitive paper stock. The label provides the product name, manufacturer, listing of ingredients, instructions for use and safety and other related information. The composition described herein, in the ratios illustrated, provide pH buffering within a desired range, removal of phosphates from water, and increased effectiveness of chlorine.

For manufacturing the casing, materials such as those known in the art may be utilized. For example, ethylene-vinyl acetate copolymer is used however, other materials such as polyurethane, silicone resin, poly(vinyl acetate) and other appropriate materials be used likewise. The casing can also be prepared using a more rigid material such as silicone based polymers or Teflon in which the material is molded at melting point temperatures and cooled to produce the necessary configuration.

Injection molding is accomplished by large machines called injection molding machines. Resin is fed to a machine through what is called a hopper. Colorants are fed to the machine directly after the hopper. The resins enter the injection barrel by gravity though the feed throat. Upon entrance into the barrel, the resin is heated to the appropriate melting temperature.

The resin is injected into the mold by a reciprocating screw or a ram injector. The reciprocating screw offers the advantage of being able to inject a smaller percentage of the total shot (amount of melted resin in the barrel). The ram injector must typically inject at least 20% of the total shot while a screw injector can inject as little as 5% of the total shot.

Reference is now made to the Examples which describe various preliminary tests and data compiled during development of the invention claimed herein and which illustrate various embodiments of the invention.

### Example 1

In an initial experimental testing for pool use, the skimmer basket was removed and the composition added up-stream from the filter(s), letting the unrestricted product coat the filter, thus as the pump ran, the water was forced to pass over the composition. As such, this will also be an effective application for bodies of water that use a diatomaceous earth filter, sand filter, or cartridge filter. When the filter is cleaned the initial amount of the composition will need to be added once again.

Another application of the product for use in a pool arises via an osmosive pouch with the pouch placed in the spa skimmer basket or on top of the cartridge filter. During testing, once the product was in the pouch and placed in the filter or piping system of the spa, the water was forced to pass over the product. In order for the product to be most effective the water must pass the over the composition because the chemical exchange which occurs during this time is crucial for the composition to work effectively and efficiently. This application is also effective in water features or other bodies of water that are not as hot and temperate as spas.

Since spa water is usually hot, in the range of 99-105 degrees Fahrenheit; fine polypropylene screen tubes, the tubes where about one inch in diameter and about 5 inches long, were found to work effectively when the composition was placed inside and both ends and sealed. The tubes are prepared to hold enough of the composition for 1-3 months of normal spa use, in a 500 gallon spa. A mesh screen on the container vessel enables water to pass through the tubes and over the composition.

### Example 2

Using the test procedures described, the composition was also tested in a typical spa, with test results compiled in table form and are provided below in Table 1. The test spa was operated normally during the testing phases. All testing was done on the same spa with the following conditions; the spa was set at a normal temperature within the range of 101-103 degrees Fahrenheit and the water about six-nine months old. Once baseline was established, any necessary chlorine and the claimed composition were added with no other additives used. Identical conditions were used in all the testing of the claimed invention.

Testing of pH buffering was conducted over a 3 week period. After baseline testing, the composition mixture was added to the water, the water being maintained in a manner that is customary in spas. During each testing and pH measurement, chlorine levels were measured after at least 8 hours. The pH of the water was tested and was consistently found to be in the normal range of between 7.2 and 7.8. Testing showed that a period of time of at least 2 to 4 hours was needed to pass before achieving an accurate measurement, depending on the volume of water treated.

Tests conducted also showed that the claimed invention increased the effectiveness of chlorine, the primary sanitizer used in most pools and spas. The testing was done using the same methods as described above. A baseline was established in water absent the claimed composition. Baseline was established for both levels of chlorine: total available chlorine (TAC) and free available chlorine (FAC). The product was added and tested over a period of 3 weeks. Results are shown in Table 1.

TABLE 1
WATER TEST RESULTS

| | Test | | | | | | | | | |
|---|---|---|---|---|---|---|---|---|---|---|
| | Base line | Test #1 | Test #2 | Test #3 | Test #4 | Test #5 | Test #6 | Test #7 | Ideal | |
| Type | Test | Results | Results | Results | Results | Results | Results | Results* | Range | |
| Date | Jan. 21, | Feb. 3, | Feb. 21, | Mar. 9, | Mar, 22, | Apr. 1, | Apr. 16, | May 2, | | |
| | 2010 | 2010 | 2010 | 2010 | 2010 | 2010 | 2010 | 2010 | | |
| Free Available | 0.5 | 1.5 | 2.0 | 2.0 | 1.5 | 1.5 | 2.0 | 5.0 | 1.5-4.0 | ppm |
| Chlorine (FAC) | | | | | | | | | | |
| Total Available | 1.0 | 2.0 | 2.5 | 2.5 | 2.0 | 2.0 | 2.5 | 5.0 | 2.0-4.0 | ppm |
| Chlorine (TAC) | | | | | | | | | | |
| Water pH | 7.8 | 7.5 | 7.6 | 7.3 | 7.6 | 7.6 | 7.7 | 7.0 | 7.2-7.8 | |
| Total Alkalinity (TA) | 130 | 110 | 100 | 90 | 100 | 110 | 100 | 80 | 80-100 | |
| Phosphates | <1 | <1 | <1 | <1 | <1 | <1 | <1 | <1 | <1 | ppm |

Notes:
Test #7 was tested within 12 hours of a heavy shock of chlorine.
Test Subject: Hot Tub
Volume of Pool/Spa: 650 gal
Suface type: Fiberglass
Present condition of water: Clean and clear
Type of sanitizer used: Chlorine
Type of filtration: Cartridge filter

As seen in Table 1, FAC and TAC were consistently maintained in a preferred and ideal range. In addition, water pH was consistently determined to be in the ideal range of 7.2 to 7.8 over seven test periods. Phosphate levels were also found to be below one part per million.

Certain advantages can be obtained in utilizing the present invention. Foremost, the simplicity and ease of use results in significant savings to the consumer maximizing the market potential for the composition. Significant time is also saved since pool and spa users are free of the requirement of frequent pH measurement anytime chlorine is added to water. The present invention is also effective because it produces long term buffering, in effect working to control pH balance in pool and spa water over an extended period of time when compared to administration times of buffering agents known in the art. Moreover, the invention conveys flexibility in allowing pool and spa users to employ a granular form of the claimed composition or a tablet form which may be situated in line upstream of the water filter.

The present invention is cost effective because it eliminates the need for chemicals, such as pH increasers and degreasers, phosphate removers, and de-foamers, otherwise necessary to keep a pool and spa water in proper chemical balance. The present invention also allows users more time to enjoy the pool or spa because one will spend less time maintaining the pool or spa. In yet another advantage, the present invention will provide users with an effective option in the maintaining their pool or spa. Over an extended period of use, the user will realize significant savings with regard to both time and maintenance costs.

The present invention is also easily adapted to operate and fit into any individual because it is easily adjusted. The invention may also be used in any water feature that utilizes chlorine as the primary sanitizer. In particular, the claimed composition can be used for example in decorative fountains, ponds, or any other water feature. Although the invention has been described with reference to the above examples, it will be understood that modifications and variations are encompassed within the spirit and scope of the invention. Accordingly, the invention is limited only by the following claims.

What is claimed is:

1. A composition for use in pool or spa water comprising calcium oxide and magnesium oxide wherein said composition is administered to said water as a buffering agent to maintain the pH of said pool or spa water in a range of about 7.2 to 7.8, said composition also acting to increase the sanitizing effectiveness of chlorine, said composition being administered to the water in a ratio of approximately 1 cup of said composition to about 500 gallons of pool or spa water.

2. The composition of claim 1 comprising about 60 parts by weight calcium oxide and about 40 parts by weight magnesium oxide.

3. The composition of claim 1 further comprising about 2 parts by weight to about 4 parts by weight of at least one member selected from the group consisting of binders dispersing aids and clarifiers.

4. The composition of claim 3 wherein said binders, dispersing aids, and clarifiers are selected from the group consisting of starches, sugars, homopolymers and copolymers of acrylic acids in mixtures thereof.

5. The composition of claim 1 wherein said composition is in the form of a granular powder or a compressed tablet.

6. The composition of claim 5 wherein said granular powder is packed in unit of use packaging.

7. The composition of claim 6 wherein said unit of use packaging is manufactured specifically to be incorporated for use with a particular water filter.

8. The composition of claim 1 wherein said composition is administered to said pool or spa water once every two weeks in warmer months and once every month during cooler months.

9. The composition of claim 1 wherein said composition diminishes the effects of phosphate containing compounds contained in the water, thereby diminishing the growth of algae.

10. The composition of claim 1 wherein said composition maintains the effectiveness of chlorine by breaking the chemical bonding between organic compounds and chlorine in the water, thereby freeing the chlorine to sanitize said water.

11. A method of treating a pool or spa to buffer pH in a range of between 7.2 and 7.8 and to enhance the sanitizing effectiveness of chlorine in a pool or spa in need of such treatment comprising introducing an effective amount of a composition of claim 1 into said pool or spa.

12. A method of enhancing or shortening pool or spa treatment time or both in a pool or spa being treated with a chlorine treatment product comprising introducing into said pool or spa a composition of claim 1 substantially simultaneously with the addition of said chlorine treatment product to said pool or spa.

13. The method of claim 12 wherein said pool or spa has a pool filter recirculating water intake that is fitted upstream with a unit of use packaging which is packed with the composition of claim 1.

14. The method of claim 12, wherein said composition diminishes the effects of phosphate containing compounds contained in the water, thereby diminishing the growth of algae and sanitizing said water.

15. The method of claim 12, wherein said composition maintains the effectiveness of chlorine by breaking the chemical bonding between organic compounds and chlorine in the water, thereby freeing the chlorine to sanitize said water.
